(19) United States
(12) Patent Application Publication
(10) Pub. No.: US 2016/0130155 A1
(43) Pub. Date: May 12, 2016

(54) WATER TREATMENT SYSTEM

(71) Applicant: HITACHI, LTD., Tokyo (JP)

(72) Inventors: Hisashi ISOGAMI, Tokyo (JP); Yojiro HAYASHI, Tokyo (JP); Masahide OHTA, Tokyo (JP); Satoshi YUMOTO, Tokyo (JP)

(73) Assignee: HITACHI, LTD, Tokyo (JP)

(21) Appl. No.: 14/894,241

(22) PCT Filed: Jul. 18, 2014
(86) PCT No.: PCT/JP2014/069161

§ 371 Date: Nov. 25, 2015

(30) Foreign Application Priority Data
Sep. 20, 2013 (JP) 2013-195728

(51) Int. Cl. C02F 1/00; E21B 43/40

(52) U.S. Cl. CPC C02F 1/008; E21B 43/40; C02F 2209/40; C02F 2103/10

(57) ABSTRACT

Provided is a water treatment system with which it is possible for injection water suitable for drilling to be prepared from seawater and produced water, without decreasing drilling efficiency, and with consideration to environmental protection. To achieve this, the system is equipped with: a fresh water flow passage for conducting fresh water from a desalination apparatus which desalinates seawater to obtain fresh water; a treated water flow passage for conducting treated water from a water/oil separation apparatus which removes the oil component contained in the produced water from an oilfield, to obtain treated water; and an injection water preparation flow passage in which the flows of treated water conducted through the treated water flow passage and the fresh water conducted through the fresh water flow passage converge, and injection water for injection into the oilfield is prepared.

### TECHNICAL FIELD

The present invention relates to a water treatment system.

### BACKGROUND ART

When extracting oil from an oilfield, there has been carried out a so-called water flooding process, in which injection water is injected into an oil layer in the ground, and thus the oil is pushed up over the ground from the oil layer by a pressure generated in the oil layer. As oil extraction technologies with use of the water flooding process, the technologies described in Patent Documents 1 and 2 have been known.

### CITATION LIST

### Patent Literature

{Patent Document 1}

Japanese Patent Application Publication No. 2001-002937

{Patent Document 2}

Japanese Patent Application Publication No. 2010-270170

### SUMMARY OF INVENTION

### Technical Problem

During the water flooding process, water which is referred to as produced water is pushed up along with the oil from under the ground. The produced water contains various organic and inorganic substances. Therefore, it has been an urgent issue how to deal with the produced water from a viewpoint of environmental protection. Since the produced water contains heavy metals and the like, a large scale processing is necessary to release or discard the produced water in nature. Therefore, it is preferable to reuse the produced water as the injection water in order to increase an oil recovery rate.

However, the produced water as it is, is not suitable for the injection water, because it has generally a high concentration of total dissolved solids (TDS concentration: details of TDS concentration will be described later). Further, if a Reverse Osmosis membrane (RO membrane) is used in order to reduce the total dissolved solids concentration, clogging of the RO membrane is likely to occur, and there are problems such that the RO membrane cannot be easily discarded because concentrated water, which is a by-product, contains heavy metals or the like. For these points, technologies related to agents for improving oil recovery efficiency from the oil layer are described in Patent Documents 1 and 2, however, handling or utilization of the produced water, which is produced along with oil extraction, is not disclosed.

Further, it is conceivable to use seawater, which is present in large amounts on the earth, as the injection water, in particular in areas where it is difficult to obtain fresh water. However, since many metal ions are contained in the seawater, if the seawater is used as the injection water, for example, sulfate ions react with calcium, magnesium, strontium, and the like in the ground, to produce sulfate salts in some cases. Since such sulfate salts are poorly soluble in water, when the sulfate salts are produced in the ground, clogging occurs in a pipe connecting the underground (oil layer) and the ground, and oil extraction efficiency is reduced in some cases. For seawater desalination, it is effective to reduce the sulfate ion concentration by treating with a nanofiltration membrane (NF membrane). However, it is said that use of the RO membrane is suitable for reducing not only the sulfate ion concentration but the total dissolved solids concentration.

The present invention has been made in view of the above circumstances, and an object of the present invention is to provide a water treatment system capable of preparing the injection water from the seawater and the produced water, the injection water being capable of extracting oil without reducing oil extraction efficiency, while considering environmental protection.

### Solution to Problem

As a result of intensive studies in order to solve the above problems, the present inventors have found that it is possible to solve the problems by producing injection water by mixing the produced water to the fresh water obtained by desalination of seawater.

### Advantageous Effects of Invention

According to the present invention, it is possible to provide a water treatment system capable of preparing the injection water from the seawater and the produced water, the injection water being capable of extracting oil without reducing oil extraction efficiency excessively, while considering environmental protection.

### BRIEF DESCRIPTION OF DRAWINGS

FIG. 1 is a system diagram of a water treatment system according to a first embodiment;

FIG. 2 is a control flow in the water treatment system according to the first embodiment;

FIG. 3 is a control flow in a water treatment system according to a second embodiment;

FIG. 4 is a control flow in a water treatment system according to a third embodiment; and

FIG. 5 is a control flow in a water treatment system according to a fourth embodiment.

### DESCRIPTION OF EMBODIMENTS

Hereinafter, embodiments (present embodiments) implementing the present invention will be described with reference to the drawings as appropriate.

### 1. First Embodiment

### <Configuration>

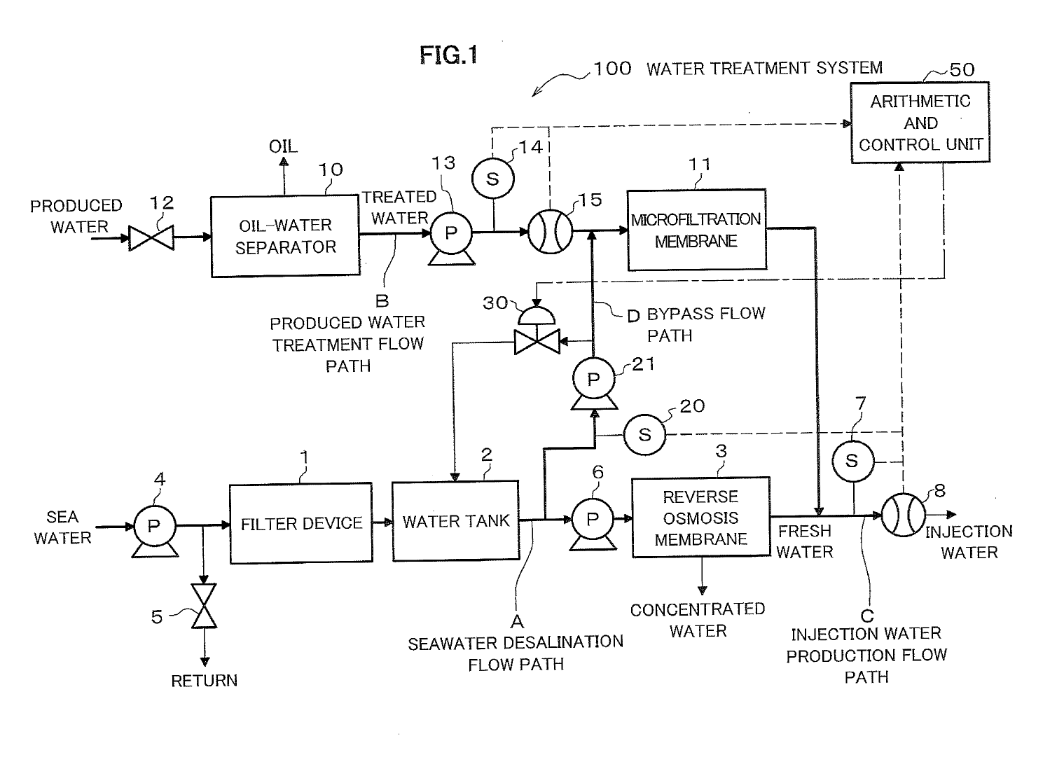

FIG. 1 is a system diagram of a water treatment system 100 according to a first embodiment. The water treatment system 100 is configured to include four flow paths of a seawater desalination flow path A, a produced water treatment flow path B, an injection water production flow path C, and a bypass flow path D. Hereinafter, the water treatment system according to the first embodiment will be described while showing specific values, however, these values are merely an example, and the embodiment is not limited thereto.

The seawater desalination flow path A is for obtaining fresh water by desalination of seawater. The fresh water which is obtained through the seawater desalination flow path A becomes a part of injection water to be described later. A flow rate of the seawater to be supplied to the seawater desalination flow path A is 50,000 barrels/day (1 barrel is about 159 1). Further, in the first embodiment, total dissolved solids concentration in the seawater is 35,000 mg/L, and sulfate salt concentration is 3,000 mg/L.

Note that, in this specification, “total dissolved solids (Total Dissolved Solids; TDS)” refers to metal salts which are contained in the seawater, produced water, or the like. Such metal salts are, for example, sulfate salts or metal chlorides. The metal salts are ionized into minus ions (for example, sulfate ions or chloride ions) and metal ions (for example, magnesium ions or sodium ions) constituting the metal salts, to be dissolved in the seawater, the produced water, or the like.

The seawater desalination flow path A is provided with a filter device 1 for removing foreign matter by filtering the seawater, a water tank 2 for storing the seawater after removing the foreign matter, and a reverse osmosis membrane 3 (seawater desalination device) for desalination of seawater. Further, the seawater desalination flow path A is provided with pumps 4, 6 for feeding the seawater which flows through the flow path, and a valve 5 for adjusting an amount of the seawater to be supplied to the filter device 1 based on a water level in the water tank 2.

The filter device 1 is, for example, a sand filtration device (multimedia filter (MMF)). By this device, the foreign matter (dust or the like) in the seawater is removed, and clear seawater is supplied to the water tank 2.

The water tank 2 is for storing the seawater which is clarified by the filter device 1. The water tank 2 is provided with a water level sensor (not shown) for measuring the water level in the water tank 2. An opening degree of the valve 5 is controlled so that the water level in the water tank 2 is constant, and excess seawater is returned to the ocean through the valve 5. Note that, in addition to the seawater flowing through the filter device 1, seawater returned from the bypass flow path D to be described later is also supplied to the water tank 2.

The reverse osmosis membrane 3 is for obtaining fresh water by permeation of the seawater from the water tank 2 while applying pressure to the seawater. That is, in the first embodiment, on a downstream side of the reverse osmosis membrane 3, a fresh water flow path through which the fresh water flows is formed. In the reverse osmosis membrane 3, in addition to obtaining fresh water, a concentrated water in which ions or the like are concentrated is produced, and the concentrated water is returned to the ocean. By flowing through the reverse osmosis membrane 3, the TDS and the like contained in the seawater are removed, and the obtained fresh water flows through the injection water production flow path C to be described later.

In the first embodiment, out of the seawater of 50,000 barrels/day which is supplied to the seawater desalination flow path A, the seawater of 40,000 barrels/day is supplied to the reverse osmosis membrane 3. Then, in the reverse osmosis membrane 3, out of the seawater of 40,000 barrels/day which is supplied thereto, the fresh water of 16,000 barrels/day and the concentrated water of 24,000 barrels/day are produced. Further, the remaining seawater of 10,000 barrels/day, which is not supplied to the reverse osmosis membrane 3, is supplied to the produced water treatment flow path B through the bypass flow path D, although the details will be described later.

The produced water treatment flow path B is for obtaining treated water by removing oil contained in the produced water from an oilfield. In the first embodiment, a flow rate of the produced water to be supplied to the produced water treatment flow path B is 10,000 barrels/day. Further, in the first embodiment, the total dissolved solids concentration in the produced water is 100,000 mg/L, and the sulfate salt concentration is 1,500 mg/L. Furthermore, an amount of oil contained in the produced water is 1,000 mg/L or less, and a total solids content (Solids State; SS) is 300 mg/L or less.

The produced water treatment flow path B is provided with an oil-water separator 10 for removing oil contained in the produced water from the oilfield, and a microfiltration membrane (microfilter) 11 for filtering the treated water which is obtained by removing oil.

Further, the produced water treatment flow path B is provided with a valve 12 for adjusting the flow rate of the produced water, a pump 13 for feeding the treated water which flows through the flow path, an ion concentration sensor 14 (treated water ion concentration sensor) for measuring an ion concentration C1 in the treated water, and a flow rate sensor 15 (treated water flow rate sensor) for measuring a flow rate Q1 of the treated water.

The oil-water separator 10 is for obtaining the treated water by removing oil from the produced water. That is, in the first embodiment, on a downstream side of the oil-water separator 10, a treated water flow path through which the treated water flows is formed. The oil-water separator 10 is, for example, a flocculation magnetic separator, a pressurized dissolved air flotation device, an induced gas flotation (IGF) separator, a compact flotation unit (CFU), or the like. However, in the first embodiment, the flocculation magnetic separator is used. By using this, it is possible to remove oil from the produced water more efficiently, thereby reducing a load of the microfiltration membrane 11 to be described later. Specifically, an amount of oil in the treated water which is obtained through the oil-water separator 10 is reduced to 5 mg/L or less. Since the oil, which is removed from the oil-water separator 10, has a floc shape containing water, after dehydration using a dehydrator such as a centrifuge, a screw press, a belt press, or the like (although they are not shown), the oil is treated by drying and incineration, landfill, or the like.

The microfiltration membrane 11 is for removing a solid content in the treated water. Therefore, since the treated water is permeated through the microfiltration membrane 11, the solid content in the treated water is removed. Specifically, in the first embodiment, the total solids content in the treated water after permeation through the microfiltration membrane 11 is 0.2 mg/L or less.

Note that, although details will be described later, to the treated water (10,000 barrels/day) which is obtained through the oil-water separator 10, the seawater (10,000 barrels/day as described above) flowing through the seawater desalination flow path A is mixed through the bypass flow path D. Therefore, the TDS (including sulfate salts) in the treated water is diluted. Specifically, in the first embodiment, the TDS in the treated water after permeation through the microfiltration membrane 11, that is, the TDS in the treated water which is mixed to the injection water production flow path C, is 67,500 mg/L, and the sulfate salt concentration out of this is 2,250 mg/L.

The ion concentration sensor 14 is for measuring the ion concentration C1 of the treated water. In the first embodiment, at least one of TDS concentration, calcium ion concentration, magnesium ion concentration, and sulfate ion concentration is measured. Here, water quality variation of the produced water occurs over a relatively long time in many cases. Therefore, usually, responsiveness is not required in the measurement. Thus, for convenience of illustration, the ion sensor 14 is provided so as to be inline measurable in FIG. 1, however, as for calcium ion, magnesium ion, and sulfate ion, it is assumed that analysis is carried out separately by obtaining the treated water at a position of the ion concentration sensor 14.

The flow rate sensor 15 is for measuring the flow rate of the treated water which is obtained through the oil-water separator 10. The ion concentration sensor 14 and the flow rate sensor 15 are connected to an arithmetic and control unit 50 through electrical signal lines shown by dashed lines in FIG. 1. The arithmetic and control unit 50 will be described later.

The injection water production flow path C is for preparing the injection water for promoting oil extraction by injecting the produced water to the oilfield from which the produced water is pumped up. Specifically, in the injection water production flow path C, to the fresh water (12,000 barrels/day) which is obtained through the seawater desalination flow path A, the treated water (20,000 barrels/day) through the microfiltration membrane 11 is mixed (merged in the flow path C), and thus the injection water (32,000 barrels/day) is obtained. Note that, in the first embodiment, the TDS concentration of the injection water which is obtained through the injection water production flow path C is 37,500 mg/L, and the sulfate salt concentration out of this is 1,250 mg/L.

The injection water production flow path C is provided with an ion concentration sensor 7 (injection water ion concentration sensor) for measuring an ion concentration Ct of the injection water, and a flow rate sensor 8 (an injection water flow rate sensor) for measuring a flow rate Qt of the injection water. The ion concentration sensor 7 is for measuring ion concentration in the injection water in the same manner with the ion concentration sensor 14. Since a measurement method and ions as measurement objects by the ion concentration sensor 7 are the same as the ion concentration sensor 14, the description will be omitted.

Further, the ion concentration sensor 7 and the flow rate sensor 8 are connected to the arithmetic and control unit 50 through electrical signal lines shown by dashed lines in FIG. 1. The arithmetic and control unit 50 will be described later.

The bypass flow path D is for mixing at least a part of the seawater, which flows through the seawater desalination flow path A, to the treated water which flows through the produced water treatment flow path B. The bypass flow path D is provided with a pump 21 for feeding the seawater, and a return valve 30 for controlling a flow rate Qm of the seawater to be supplied to the produced water treatment flow path B. Further, the bypass flow path D is provided with an ion concentration sensor 20 (a bypass flow path ion concentration sensor) for measuring an ion concentration Cm of the seawater to be supplied to the produced water treatment flow path B. Since a measurement method and ions as measurement objects by the ion concentration sensor 20 are the same as the ion concentration sensor 14, the description will be omitted.

The return valve 30 is for returning the seawater, which is obtained from the seawater desalination flow path A, to the water tank 2 which is provided in the seawater desalination flow path A. That is, when the flow rate Qm of the seawater which is fed by the pump 21 is greater than a desired flow rate, a part of the seawater is returned to the water tank 2 by increasing an opening degree of the valve 30. In the first embodiment, the flow rate of the seawater which is fed by the pump 21 is constant, and the flow rate of the seawater which is supplied to the produced water treatment flow path B is controlled by adjusting the opening degree of the return valve 30. Therefore, in the first embodiment, a correlation (calibration curve, table, or the like) between the opening degree of the return valve 30 and the flow rate Qm of the seawater, which is supplied to the produced water treatment flow path B, is recorded in the arithmetic and control unit 50. Then, the arithmetic and control unit 50 is adapted to adjust the opening degree of the return valve 30 based on the recorded correlation, so that the flow rate Qm of the seawater to be supplied becomes the desired flow rate, although the details will be described later. Note that, in the above example, the seawater flowing through the bypass flow path D is mixed to the treated water flowing through the produced water treatment flow path B, however, if the seawater is not necessary to flow through the microfiltration membrane 11, the bypass flow path D may be connected to an outlet side flow path of the microfiltration membrane 11. In this case, there is an effect that can reduce the load of the microfiltration membrane 11.

The arithmetic and control unit 50 is for determining the flow rate Qm of the seawater to be supplied to the produced water treatment flow path B, based on the ion concentrations Ct, C1, Cm measured by the ion concentration sensors 7, 14, 20, and the flow rates Qt, Q1 measured by the flow rate sensors 8, 15. Further, the arithmetic and control unit 50 is also adapted to adjust the opening degree of the return valve 30 so that the flow rate of the seawater becomes the determined flow rate Qm. A specific control method of the opening degree of the return valve 30 will be described later in a section of <Operation>.

Incidentally, the arithmetic and control unit 50 includes a CPU (Central Processing Unit), a RAM (Random Access Memory), a ROM (Read Only Memory), a HDD (Hard Disk Drive), I/F (Interfaces), and the like, although they are not shown, and is implemented by executing a predetermined control program stored in the ROM by the CPU.

### <Operation>

Next, a control in the water treatment system 100 will be described.

In the water treatment system 100, for example, because of time degradation of the reverse osmosis membrane 3 or the oil-water separator 10, the ion concentration C1 and the flow rate Q1 of the treated water which is obtained by passing through the oil-water separator 10, and an ion concentration Cr and a flow rate Qr of the fresh water which is obtained by permeation through the reverse osmosis membrane 3, are varied in some cases. As a result, the ion concentration Ct and the flow rate Qt of the injection water, which is produced by mixing the treated water and the fresh water, vary from conditions during a test operation of the water treatment system 100 in some cases. Therefore, in the first embodiment, by controlling the flow rate Qm of the seawater to be supplied to the produced water treatment flow path B based on several parameters, it is possible to prevent the ion concentration Ct and the flow rate Qt of the injection water from varying significantly. Specifically, the flow rate Qm of the seawater to be supplied to the produced water treatment flow path B is determined and controlled based on the flow rate Q1 of the treated water, the ion concentration C1 of the treated water, the flow rate Qt of the injection water, the ion concentration Ct of the injection water, and the ion concentration Cm of the seawater to be supplied to the produced water treatment flow path B. First, a method for determining the flow rate Qm will be described in the following.

First, as described above, it is assumed that the ion concentration measured by the ion concentration sensor 7 is Ct, the flow rate measured by the flow rate sensor 8 is Qt, the ion concentration measured by the ion concentration sensor 14 is C1, and the flow rate measured by the flow rate sensor 15 is Q1. Further, if it is assumed that the flow rate and the ion concentration of the fresh water, which is obtained by permeation through the reverse osmosis membrane 3, are respectively Qr and Cr, a following formula (1) is derived based on the law of conservation of mass.

Q1·C1+Qm·Cm+Qr·Cr=Qt·Ct

Qm=(Qt·Ct−Q1·C1−Qr·Cr)/Cm formula (1)

Here, since the ion concentration Cr of the fresh water is almost equal to 0, if Cr is assumed to be 0, a following formula (2) is obtained.

Qm=(Qt·Ct−Q1·C1)/Cm formula (2)

By substituting the flow rates Qt, Q1 measured by the flow rate sensors 8, 15, and the ion concentrations Ct, C1, Cm measured by the ion concentration sensors 7, 14, 20 in the formula (2), the flow rate Qm of the seawater to be supplied to the produced water treatment flow path B can be calculated.

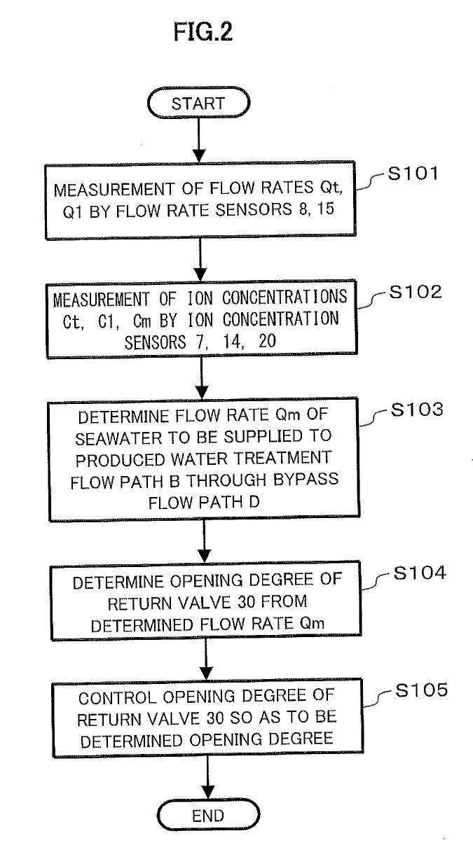

Hereinafter, a specific control flow of the flow rate Qm in the water treatment system 100 according to the first embodiment will be described with reference to FIG. 2.

FIG. 2 is a control flow in the water treatment system 100 according to the first embodiment. The control flow shown in FIG. 2 is carried out by the arithmetic and control unit 50. First, the arithmetic and control unit 50 measures the flow rate Qt with use of the flow rate sensor 8, and the flow rate Q1 of the treated water with use of the flow rate sensor 15 (Step S101). The measured flow rates Qt, Q1 are obtained by the arithmetic and control unit 50. Next, the arithmetic and control unit 50 measures the ion concentration Ct of the injection water with use of the ion concentration sensor 7, the ion concentration C1 of the treated water with use of the ion concentration sensor 14, and the ion concentration Cm of the seawater flowing through the bypass flow path D with use of the ion concentration sensor 20 (Step S102). The measured ion concentrations Ct, C1, and Cm are obtained by the arithmetic and control unit 50.

Next, the arithmetic and control unit 50 determines the flow rate Qm of the seawater to be supplied to the produced water treatment flow path B through the bypass flow path D (Step S103). Specifically, in the first embodiment, the arithmetic and control unit 50 determines the flow rate Qm by substituting measured values of the five parameters in the formula (2). And, the arithmetic and control unit 50 determines the opening degree of the return valve 30 from the determined flow rate Qm based on the correlation, which is stored in advance, between the opening degree of the return valve 30 and the flow rate Qm (Step S104). Then, the arithmetic and control unit 50 controls the opening degree of the return valve 30 so as to be the determined opening degree (Step S105). As a result, the seawater of the flow rate Qm, which is determined in Step S103, is supplied to the produced water treatment flow path B.

### <Effects>

According to the first embodiment, even if the ion concentration C1 and the flow rate Q1 of the treated water, which is obtained by passing through the oil-water separator 10, and the flow rate and the like of the fresh water, which is obtained by permeation through the reverse osmosis membrane 3 are, for example, varied because of time degradation of various devices, it is possible to prevent the ion concentration Ct and the flow rate Qt of the injection water from varying significantly. Therefore, it is possible to prepare the injection water capable of stably extracting oil without significant variation of injection water conditions which are set in advance and suitable for oil extraction.

Here, the treated water contains a large amount of TDS (salt). Although the injection water preferably contains a certain amount of salt in order to improve oil extraction efficiency, excessive salt reduces oil extraction efficiency in some cases.

Therefore, it is difficult to use the produced water or the treated water as it is as the injection water.

Further, even if it is intended that the treated water is, for example, desalinated by a reverse osmosis membrane, it is difficult to desalinate the treated water by the reverse osmosis membrane, because the produced water contains a very large amount of salt. Further, since various substances other than oil are also contained in the produced water, if the produced water is supplied to the reverse osmosis membrane, there is a possibility that a degradation rate of the reverse osmosis membrane is accelerated. Therefore, it is usually difficult to use the produced water as the injection water. Furthermore, even if the produced water can be desalinated by the reverse osmosis or the like, a concentrated water to be produced contains various ions and the like. Therefore, there is a possibility that the concentrated water cannot be released to the outside as it is.

In addition to these, because of the same reason as a reason why it is difficult to use the treated water as it is as the injection water, it is also difficult to use the seawater containing a large amount of salt as it is as the injection water. In particular, when the seawater is used as it is as the injection water, oil extraction efficiency is reduced in some cases, and further, sulfate ions and the like contained in the seawater and calcium, magnesium, strontium, and the like in the ground are chemically bonded, to produce poorly soluble sulfate salts in some cases. Then, by the salts, a pipe connecting the oil layer and above ground is clogged, to reduce oil extraction efficiency in some cases.

However, in the first embodiment, the treated water is produced by removing oil from the produced water, and by mixing the treated water with the fresh water obtained by desalination of seawater, the injection water is prepared. In particular, since the produced water is used to be mixed with the fresh water, it is possible to increase the flow rate of the injection water. In this manner, according to the first embodiment, the produced water can be used to prepare the injection water, although treatment of the produced water has been complicated and utilization of the produced water as the injection water has been also conventionally complicated. As a result, it is possible to reduce the produced water (including the produced water after treatment) which is discharged to the outside, and thus it is advantageous from a viewpoint of environmental protection.

Further, in the first embodiment, instead of treating all of the intaken seawater by the reverse osmosis membrane 3, a part of the intaken seawater flows through the bypass flow path D, to be supplied to the produced water treatment flow path B. In particular, the TDS and the like are not removed by the microfiltration membrane 11, however, as described above, it is preferable that the injection water contains a certain amount of TDS and the like. Therefore, if the concentration of the TDS and the like contained in the injection water is in a preferred range, it is not necessary to remove the TDS and the like in the seawater by desalinating all of the seawater through the reverse osmosis membrane 3. Since the reverse osmosis membrane 3 is more elaborate than the microfiltration membrane 11, it is possible to reduce the degradation rate of the reverse osmosis membrane 3 by reducing the amount of the seawater to be supplied to the reverse osmosis membrane 3. As a result, it is possible to reduce replacement frequency of the reverse osmosis membrane 3, thereby reducing cost.

### 2. Second Embodiment

A water treatment system according to a second embodiment has basically the same device configuration as the water treatment system 100 according to the first embodiment. However, in the second embodiment, a control which is different from that of the first embodiment is performed. Therefore, description of the device configuration is omitted, and the second embodiment will be described focusing on the control performed in the second embodiment.

In the first embodiment, the control is performed based on five measured values. However, the water treatment system 100 is operated at a constant flow rate of the produced water (that is, a constant flow rate Q1 of the treated water to be obtained) in some cases. Further, the ion concentration (C1 ; measured by the ion concentration sensor 14) of the produced water and the ion concentration Cm of the seawater do not usually vary significantly. Therefore, as a simpler control, by assuming that these parameters are constants (values measured during test operation) in the formula (2), it is possible to determine the flow rate Qm of the seawater flowing through the bypass flow path D based on the ion concentration Ct and the flow rate Qt of the injection water. In other words, the flow rate Qm of the seawater to be supplied to the produced water treatment flow path B can be calculated based on the following formula (3) which is obtained by modifying the formula (2).

Qm=(Qt·Ct−Q1C1)/Cm=Qt·Ct/Cm−Q1C1/Cm=a·Qt·Ct−b formula (3)

Here, a and b are constants.

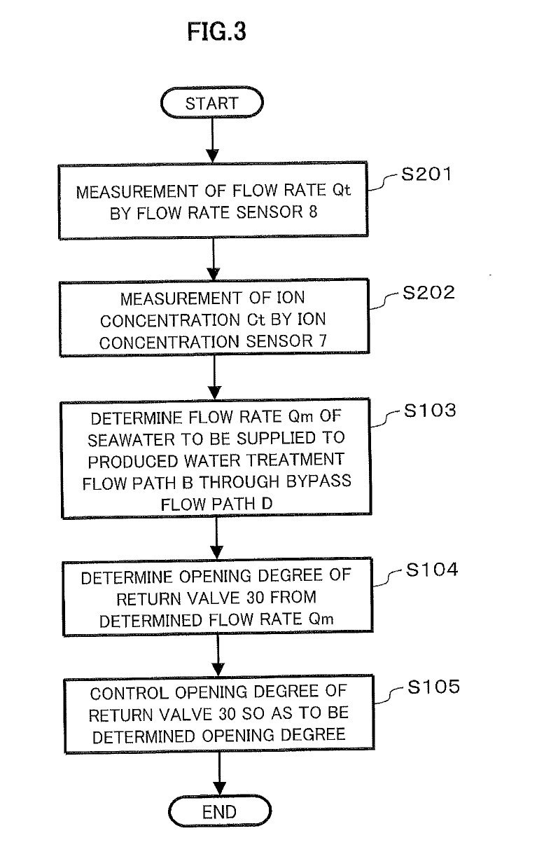

FIG. 3 is a control flow in the water treatment system according to the second embodiment. In FIG. 3, the same steps as the flow shown in FIG. 2 are denoted by the same reference numerals, and detailed descriptions thereof will be omitted. The control flow shown in FIG. 3 is carried out by the arithmetic and control unit 50.

First, the arithmetic and control unit 50 measures the flow rate Qt of the injection water by the flow rate sensor 8 (Step S201). Further, the arithmetic and control unit 50 measures the ion concentration Ct of the injection water by the ion concentration sensor 7

(Step S202). And, by substituting the two measured values in the formula (3), the flow rate Qm of the seawater to be supplied to the produced water treatment flow path B is determined (Step S103). Then, in the same manner as the first embodiment, the opening degree of the return valve 30 is controlled (Steps S104 and S105). As a result, the seawater of the flow rate Qm, which is determined in Step S103, is supplied to the produced water treatment flow path B.

By controlling the water treatment system by using the formula (3), variables are two, and thus a simple control can be carried out. In particular, water quality (ion concentration and the like) of the produced water and the seawater does not vary significantly, or varies slowly over a relatively long time even if it varies. Therefore, by determining the flow rate Qm by assuming that the flow rate of the produced water (that is, the flow rate Q1 of the treated water), the ion concentration of the produced water (that is, the ion concentration C1 of the treated water), and the ion concentration Cm of the seawater are constants, the control can be simplified while having a sufficient accuracy similarly to the first embodiment.

Note that, in an example described above, the water treatment system is controlled by measuring the ion concentration Ct and the flow rate Qt of the injection water, however, it can also be controlled based on only either one as a more simplified control. For example, if the flow rate of the seawater and the flow rate of the produced water to be taken in the water treatment system 100 are constant, the flow rate Qt of the injection water is also usually constant. Therefore, in addition to the above three parameters, by assuming that the flow rate Qt of the injection water is also a constant, it is possible to determine the flow rate Qm of the seawater to be supplied to the produced water treatment flow path B based on the ion concentration Ct of the injection water. Further, for example, if the flow rate of the treated water obtained in treatment by the oil-water separator 10 varies significantly, the flow rate of the injection water is also likely to vary significantly. Therefore, in this case, by assuming that the ion concentration Ct of the injection water is a constant, it is possible to determine the flow rate Qm of the seawater to be supplied to the produced water treatment flow path B based on the flow rate Qt of the injection water.

### 3. Third Embodiment

As described above, from a viewpoint of good oil extraction efficiency, it is found that the injection water has a preferred range of concentration of each ion (TDS, sulfate ion, calcium ion, magnesium ion, or the like) contained therein. Further, since the oil in the oil layer decreases as an amount of extracted oil increases, it is preferable to increase an amount of the injection water. Therefore, even if the ion concentration of the injection water is the same, it is sometimes desired to increase the amount of the injection water to be prepared.

Therefore, in the first embodiment or the like, the control for suppressing condition variations of the injection water accompanying to the time degradation or the like has been described, however, in the third embodiment, a control capable of preparing the injection water having desired conditions (the ion concentration Ct and the flow rate Qt) will be described. Note that, since a device configuration of a water treatment system 100 is the same as that of the first embodiment shown in FIG. 1, its description and illustration will be omitted.

Further, the TDS in the injection water varies depending on geological formation of the oilfield, however, the TDS is, for example, more than or equal to 1,000 mg/L and less than or equal to 100,000 mg/L, and preferably more than or equal to 1,000 mg/L and less than or equal to 40,000 mg/L. Therefore, in the third embodiment, it is assumed that the TDS in the injection water to be prepared can be controlled to be in this range. In particular, there is cited a case in which an ion concentration set value C2 for the TDS in the injection water is 50,000 mg/L which is substantially an intermediate value in this range, so that there is no problem even if the TDS concentration varies to some extent.

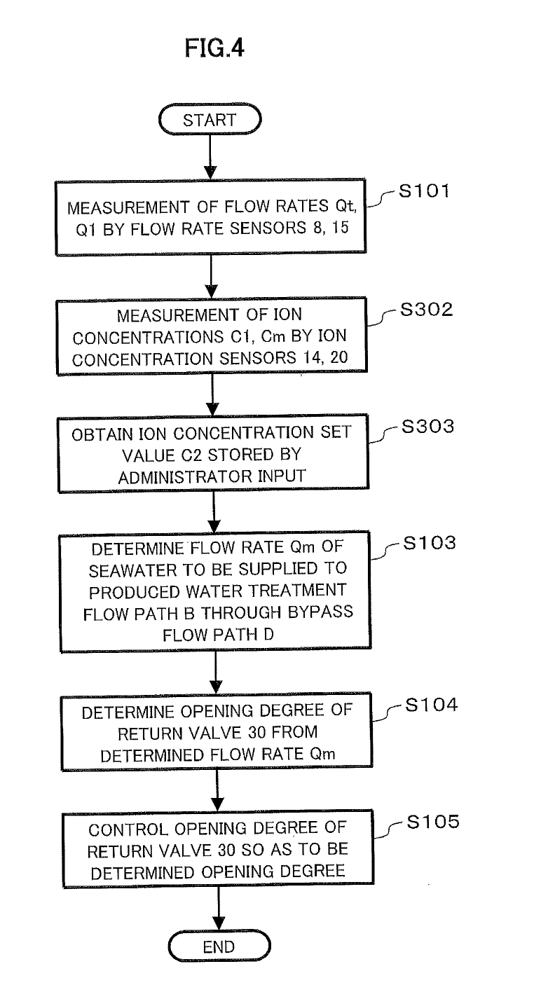

FIG. 4 is a control flow in the water treatment system 100 according to the third embodiment. In FIG. 4, the same steps as the flow shown in FIG. 2 are denoted by the same reference numerals, and detailed descriptions thereof will be omitted. The control flow shown in FIG. 4 is carried out by the arithmetic and control unit 50.

First, the arithmetic and control unit 50 measures the two flow rates Qt, Q1 in the same manner as Step S101 in FIG. 2 (Step S101). The measured flow rates Qt, Q1 are obtained by the arithmetic and control unit 50. Next, the arithmetic and control unit 50 measures the ion concentration C1 of the treated water by the ion concentration sensor 14, and the ion concentration Cm of the seawater by the ion concentration sensor 20 (Step S302). Here, the ions to be measured by the ion concentration sensors 14, 20 are the ions set in the preferred range for the injection water, and are the TDS in the third embodiment. The measured ion concentrations C1, Cm are obtained by the arithmetic and control unit 50.

Next, the arithmetic and control unit 50 obtains the ion concentration set value C2, which is inputted through an input unit (not shown) by an administrator, and stored in a storage unit (not shown) (Step S303). This is an alternative to the measured value of the ion concentration Ct measured by the ion concentration sensor 7 in the first embodiment.

And, by using the four measured conditions (the two flow rates Qt, Q1, and the two ion concentrations C1, Cm), and the ion concentration set value C2 set by the administrator, the arithmetic and control unit 50 determines the flow rate Qm of the seawater to be supplied to the produced water treatment flow path B (Step S103). In this case, the ion concentration set value C2, which has been set, is used in place of the flow rate Ct in the formula (2). Then, in the same manner as the first embodiment, the opening degree of the return valve 30 is controlled (Steps S104 and S105). As a result, the seawater of the flow rate Qm, which is determined in Step S103, is supplied to the produced water treatment flow path B.

Although the five measured values are used in the first embodiment, the four measured values and one set value are used in the third embodiment. And, the flow rate Qm corresponding to this one set value is determined. In this manner, it is possible to prepare the injection water which is, for example, set to have a desired concentration of the TDS by using the seawater and the produced water. As a result, it is possible to prepare the injection water capable of having good oil extraction efficiency, thereby improving the oil extraction efficiency.

Note that, there is cited the TDS as a component in the preferred range of the ion concentration Ct in the above example, however, for example, sulfate concentration (sulfate ion concentration), calcium ion concentration, or magnesium ion concentration may be adjusted to be in a preferred range. Then, in accordance with the ions to be adjusted, kinds of the ions, which are measured by the ion concentration sensors 14, 20, only have to be changed. Each preferred range is not generalized because it varies depending on geological formation or the like of the oilfield, however, the calcium ion concentration of the injection water is, for example, more than or equal to 100 mg/L and less than or equal to 10,000 mg/L, and preferably more than or equal to 150 mg/L and less than or equal to 2,000 mg/L. Further, the sulfate ion concentration of the injection water is, for example, more than or equal to 10 mg/L and less than or equal to 500 mg/L, and preferably more than or equal to 10 mg/L and less than or equal to 100 mg/L, That the preferred ranges of these ions are all satisfied is in particular preferable, however, one or more of these ranges may be satisfied.

In addition, if it is desired to change the flow rate Qt while maintaining the ion concentration Ct of the injection water, in the same manner as the case of change in the ion concentration described above, a set flow rate which is a desired flow rate may be substituted in the formula (2) in place of the measured value of the flow rate Qt measured by the flow rate sensor 8. Thus, the injection water having both of the desired flow rate Qt and the ion concentration Ct can be prepared.

As described above, the fresh water used in the preparation of the injection water can be obtained by desalination of seawater, and is water from which the TDS or the like contained in the seawater is removed. Therefore, the fresh water used in the preparation of the injection water can be obtained with any seawater desalination technology. As described above, there is a preferred range for concentration of the TDS or the like in the injection water, however, since the TDS or the like is contained in the produced water, the fresh water, which is obtained with any seawater desalination technology, can contain the TDS or the like by using the produced water, because the TDS or the like is contained in the produced water. In particular, in the third embodiment, in accordance with the ion concentration C1 and the flow rate Q1 of the treated water which is obtained by removing oil from the produced water, the injection water can contain an amount of ions suitable for oil extraction, and a desired amount of injection water can also be obtained.

### 4. Fourth Embodiment

In the second embodiment, the simplified control has been described, and in the third embodiment, the control capable of appropriately changing the conditions (the flow rate Qt and the ion concentration Ct) of the injection water to be prepared has been described. However, according to the present embodiment, a control combining these can be carried out. Therefore, in the fourth embodiment, a simplified control method capable of appropriately changing the conditions of the injection water to be prepared will be described. Note that, in the fourth embodiment, the control method will be described with a case, in which the ion concentration of the injection water is set to be the ion concentration set value C2 similarly to the third embodiment, as an example.

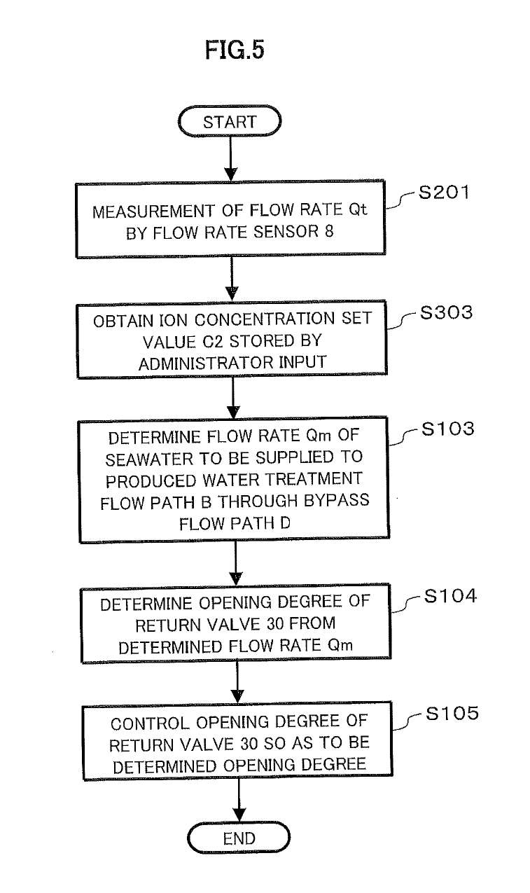

FIG. 5 is a control flow in a water treatment system according to the fourth embodiment. The same steps as the flows shown in FIGS. 2 to 4 are denoted by the same reference numerals, and detailed descriptions thereof will be omitted. The control flow shown in FIG. 5 is carried out by the arithmetic and control unit 50.

First, in the same manner as the second embodiment, the arithmetic and control unit 50 measures the flow rate Qt of the injection water by the flow rate sensor 8 (Step S201). Next, in the same manner as the third embodiment, the arithmetic and control unit 50 obtains the ion concentration set value C2 (Step S303). And, the arithmetic and control unit 50 determines the flow rate Qm of the seawater to be supplied to the produced water treatment flow path B by using the measured flow rate Qt and the ion concentration set value C2 which has been set (Step S103). In this case, the ion concentration set value C2, which has been inputted, is used in place of the flow rate Ct in the formula (3). Then, in the same manner as the first embodiment, the opening degree of the return valve 30 is controlled (Steps S104 and S105). As a result, the seawater of the flow rate Qm, which is determined in Step S103, is supplied to the produced water treatment flow path B.

According to the fourth embodiment, as in the second embodiment and the third embodiment, the ion concentration Ct of the injection water can be a desired value by the simplified control. Further, similarly to the third embodiment, when the flow rate Qt of the injection water is intended to be a desired value, the ion concentration Ct of the injection water is measured, and the flow rate Qm of the seawater may be calculated by using the formula (3).

### 5. Modified Example

Hereinabove, the present embodiments have been described with some embodiments, however, the present embodiments are not limited to the above-described examples. That is, the present invention can be implemented by arbitrarily modifying the above-described embodiments in a range without departing from the spirit of the present invention.

For example, the present invention can be implemented by appropriately combining the above-described embodiments with each other. Specifically, for example, the control (the second embodiment, the fourth embodiment, or the like) may be carried out by the administrator so that the ion concentration and the flow rate of the injection water are changed as needed, while the control (the first embodiment, the third embodiment, or the like), in which the arithmetic and control unit 50 monitors the ion concentration Ct and the flow rate Qt of the injection water always or at predetermined intervals so that these values do not change significantly, is carried out.

Further, for example, in each of the embodiments described above (FIG. 1), the seawater desalination flow path A is provided with the seawater desalination device (reverse osmosis membrane 3), and the produced water treatment flow path B is provided with the oil-water separator 10. In other words, in each of the embodiments described above, the seawater desalination flow path A is configured to include the flow path through which the seawater flows, the reverse osmosis membrane 3, and the flow path (fresh water flow path) through which the fresh water flows. Further, the produced water treatment flow path B is configured to include the flow path through which the produced water flows, the oil-water separator 10, and the flow path (treated water flow path) through which the treated water flows. However, if the flow path (fresh water flow path) through which the fresh water flows from the seawater desalination device is provided, there is no need that the seawater desalination device or the like is necessarily provided. Similarly, if the flow path (treated water flow path) through which the treated water flows from the oil-water separator is provided, there is no need that the oil-water separator or the like is necessarily provided.

Further, for example, in each of the embodiments described above (FIG. 1), at least a part of the seawater flowing through the seawater desalination flow path A in FIG. 1 is supplied to the treated water flowing through the produced water treatment flow path B. However, the seawater to be supplied to the treated water may not necessarily be the seawater flowing through the seawater desalination flow path A in FIG. 1. Specifically, for example, the seawater may be taken in a system different from the system shown in the water treatment system 100 in FIG. 1, and the seawater which is taken may be supplied to the treated water flowing through the produced water treatment flow path B.

Further, for example, in the water treatment system 100 shown in FIG. 1, the flow rate of the seawater flowing through the bypass flow path D is changed by adjusting the opening degree of the return valve 30, however, in place of the return valve 30 and the pump 21, an inverter control pump may be provided in the bypass flow path D. Thus, by changing a rotational frequency of the pump, the flow rate Qm of the seawater to be supplied to the produced water treatment flow path B can be changed. Further, by providing a valve capable of appropriately adjusting the flow rate in the bypath flow path D in place of the return valve 30, and by adjusting an opening degree of the valve, the flow rate Qm of the seawater to be supplied to the produced water treatment flow path B may be controlled.

Further, for example, in the above-described embodiments, each of four ion concentrations (TDS concentration, calcium ion concentration, magnesium ion concentration, and sulfate ion concentration) are measured by each ion concentration sensor, however, one to three kinds of these ion concentrations may be measured. In other words, in accordance with ions (which can be measured by the ion concentration sensor 7) contained in the injection water, the kind of the ions, which are measured by the other sensors, only have to be determined. Further, there is no need that the ion concentration sensors are necessarily inline sensors, and by providing sampling ports in place of the concentration sensors 7, 14, 20, ion concentrations in liquids, which are sampled through the sampling ports, may be measured at a separate place (chemical laboratory or the like).

Further, for example, there is no need that the seawater desalination device provided in the water treatment system 100 is necessarily the reverse osmosis membrane which is illustrated. Therefore, if it is a device capable of desalinating the seawater, it is not limited to the reverse osmosis membrane, and any device can be used. Further, in order to efficiently perform reduction of the sulfate ion concentration and reduction of the TDS concentration at the same time, a nanofiltration membrane and the reverse osmosis membrane may be provided in parallel, or three kinds of membranes of the microfiltration membrane (MF membrane), the nanofiltration membrane, and the reverse osmosis membrane may be provided in parallel. Further, the filter device 1, the water tank 2, the microfiltration membrane 11, and the like are not essential devices, and they may not be provided as needed. Furthermore, alternate devices having similar operations can be provided.

Further, for example, in each of the embodiments described above, the flow rate Qm of the seawater to be supplied to the produced water treatment flow path B from the seawater desalination flow path A is determined by using the formula (2) or the formula (3). However, a specific determination method of the flow rate Qm is not limited thereto. Therefore, it is preferred that the flow rate Qm is determined based on at least one of the ion concentration and the flow rate (both are concepts including both a measured value and a set value) of the injection water, however, the flow rate Qm may be determined by any method.

As described above, according to the present invention, it is possible to provide a water treatment system capable of preparing the injection water from the seawater and the produced water, the injection water being capable of extracting oil without reducing oil extraction efficiency, while considering environmental protection.

### REFERENCE SIGNS LIST

3: reverse osmosis membrane (seawater desalination device)

7: ion concentration sensor (injection water ion concentration sensor)

8: flow rate sensor (injection water flow rate sensor)

10: oil-water separator

14: ion concentration sensor (treated water ion concentration sensor)

15: flow rate sensor (treated water flow rate sensor)

20: ion concentration sensor (bypass flow path ion concentration sensor)

50: arithmetic and control unit

100: water treatment system

A: seawater desalination flow path (including fresh water flow path)

B: produced water treatment flow path (including treated water flow path)

C: injection water production flow path

D: bypass flow path

1. A water treatment system comprising:
a fresh water flow path through which fresh water flows from a seawater desalination device for obtaining the fresh water by desalination of seawater;
a treated water flow path through which treated water flows from an oil-water separator for obtaining the treated water by removing oil contained in produced water from an oilfield; and
an injection water production flow path for preparing injection water to be injected to the oilfield by merging the fresh water flowing through the fresh water flow path with the treated water flowing through the treated water flow path.

2. The water treatment system according to claim 1, further comprising a bypass flow path for supplying at least a part of the seawater to the treated water flowing through the treated water flow path.

3. The water treatment system according to claim 2, further comprising an arithmetic and control unit for determining a flow rate of the seawater that is supplied to the treated water flow path based on at least one of an ion concentration of the injection water and a flow rate of the injection water, and also for controlling the flow rate of the seawater so that the flow rate of the seawater is the determined flow rate.

4. The water treatment system according to claim 3, further comprising:
an injection water flow rate sensor for measuring the flow rate of the injection water flowing through the injection water production flow path; and
an injection water ion concentration sensor for measuring the ion concentration contained in the injection water flowing through the injection water production flow path, wherein the arithmetic and control unit determines the flow rate of the seawater that is supplied to the treated water flow path by using at least one of the ion concentration of the injection water that is measured by the injection water ion concentration sensor and the flow rate of the injection water that is measured by the injection water flow rate sensor.

5. The water treatment system according to claim 4, further comprising:
a treated water flow rate sensor for measuring a flow rate of the treated water flowing through the treated water flow path;
a treated water ion concentration sensor for measuring an ion concentration contained in the treated water flowing through the treated water flow path; and
a bypass flow path ion concentration sensor for measuring an ion concentration contained in the seawater flowing through the bypass flow path,
wherein the arithmetic and control unit determines the flow rate of the seawater that is supplied to the treated water flow path based on the flow rate of the injection water measured by the injection water flow rate sensor, the ion concentration of the injection water measured by the injection water ion concentration sensor, the flow rate of the treated water measured by the treated water flow rate sensor, the ion concentration of the treated water measured by the treated water ion concentration sensor, and the ion concentration of the seawater measured by the bypass flow path ion concentration sensor.

6. The water treatment system according to claim 3, further comprising an input unit to which an administrator can input at least one set value of the ion concentration of the injection water and the flow rate of the injection water,
wherein the arithmetic and control unit determines the flow rate of the seawater that is supplied to the treated water flow path by using the set value inputted to the input unit.

7. The water treatment system according to claim 6,
wherein the ion concentration is a total dissolved solids concentration, and
wherein the arithmetic and control unit determines the flow rate of the seawater that is supplied to the treated water flow path based on the set value inputted to the input unit so that the total dissolved solids concentration of the injection water flowing through the injection water production flow path is equal to 1,000 mg/L or more and equal to 100,000 mg/L or less.

8. The water treatment system according to claim 6,
wherein the ion concentration is a calcium ion concentration, and
wherein the arithmetic and control unit determines the flow rate of the seawater that is supplied to the treated water flow path based on the set value inputted to the input unit so that the calcium ion concentration of the injection water flowing through the injection water production flow path is equal to 100 mg/L or more and equal to 10,000 mg/L or less.

9. The water treatment system according to claim 6,
wherein the ion concentration is a sulfate ion concentration, and
wherein the arithmetic and control unit determines the flow rate of the seawater that is supplied to the treated water flow path based on the set value inputted to the input unit so that the sulfate ion concentration of the injection water flowing through the injection water production flow path is equal to 10 mg/L or more and equal to 500 mg/L or less.
